(19) United States
(12) Patent Application Publication
(10) Pub. No.: US 2022/0040871 A1
(43) Pub. Date: Feb. 10, 2022

(54) HANDHELD POWERED BOX CUTTER

(71) Applicants: John Decker Spitz, Merrimack, NH (US); Robert K. Spitz, Nashua, NH (US); Rob Wright, Agoura Hills, CA (US); Alan D. Crawford, Glendale, CA (US); Spencer L. Mackay, Mesa, AZ (US)

(72) Inventors: John Decker Spitz, Merrimack, NH (US); Robert K. Spitz, Nashua, NH (US); Rob Wright, Agoura Hills, CA (US); Alan D. Crawford, Glendale, CA (US); Spencer L. Mackay, Mesa, AZ (US)

(73) Assignee: 214 Central Industries, Inc, Agoura Hills, CA (US)

(21) Appl. No.: 17/393,990

(22) Filed: Aug. 4, 2021

Related U.S. Application Data
(60) Provisional application No. 63/061,673, filed on Aug. 5, 2020.

(51) Int. Cl. B26B 7/00

(52) U.S. Cl. CPC B26B 7/00

(57) ABSTRACT

The present invention describes an invention called the “Handheld Powered Box Cutter” which makes it much easier and faster to cut up cardboard packaging and boxes. It uses a handheld ergometric compact design and uses a rechargeable battery-operated motor, to drive a protected rapidly oscillating cutting blade, to ease the task of slicing various thicknesses of cardboard. The cutting blade is housed within a hooked protective cutting slot area. This slot allows pieces of cardboard to be slid into a rapidly oscillating cutting blade and it protects human fingers from being cut by the blade.

This patent application claims priority from the U.S. Provisional Application No. 63/061,673 filed Aug. 5, 2020 and entitled “Handheld Powered Box Cutter”.

### BACKGROUND OF THE INVENTION

As E-commerce delivery of products continues to grow, cardboard box use is increasing significantly. At the current time, most e-commerce products are shipped in cardboard boxes and the majority of these packages are single use. Studies show that the average household discards thousands of pieces of cardboard annually. This creates significant problems with recycling. Efficient recycling requires that cardboard boxes be cut down to efficiently fit into recycling bins. Disposing of all this consumer cardboard packaging is time consuming, not easy, and potentially hazardous.

Cardboard packing & boxes are typically cut down for disposal using manual utility knives. This is not easy, and dangerous. The exposed blades on utility knives are responsible for many thousands of injuries every year. Powered cutting devices are unwieldy for average residential usage with dangerous open cutting blades.

This patent discloses an invention called the “Handheld Powered Box Cutter”. Using this device for these tasks it is much easier and faster to cut up cardboard packaging and boxes while also being very safe, eliminating cutting injuries.

### SUMMARY OF THE INVENTION

The present invention has a handheld ergonomic compact design and uses a rechargeable battery-operated motor, to drive a protected oscillating cutting blade, to ease the task of slicing various thicknesses of cardboard. The cutting blade will wear with time, and is replaceable with a fresh blade, when it becomes dull.

The design of the device houses the cutting blade within a protective cutting slot. This slot allows pieces of cardboard to be slid into a rapidly oscillating cutting blade. While the cutting slot allows cardboard of various thicknesses to be fed and cut, it protects human fingers from being cut by the blade. The cutting end of the device is hooked, to allow it to easily slide along and slice long pieces of cardboard. The hooked cutting area is narrower than the main body of the unit. The cutting head area is tapered to allow the cut slit in the cardboard to more easily pass thru.

### BRIEF DESCRIPTION OF THE DRAWINGS

Some embodiments of the present invention are illustrated as an example and are not limited by the figures of the a accompanying drawings, in which like references may indicate similar elements and in which:

FIG. 1 depicts the overall-all device showing the ergonomic design of hand held cutter. It also illustrates the hooked cutting slot, which safely guides the cardboard to be cut, into the cutting blade area.

FIG. 2 shows an alternate view of the hand held cutter illustrating the power controls and blade replacement hatch area.

FIG. 3 depicts the internal operating mechanisms. It shows the mechanisms for powering the cutting blade using an offset cam, rocker blade-holder assembly, cutting blade, electric motor, and rechargeable battery.

### DESCRIPTION OF THE PREFERRED EMBODIMENTS

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A “Handheld Powered Box Cutter” device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

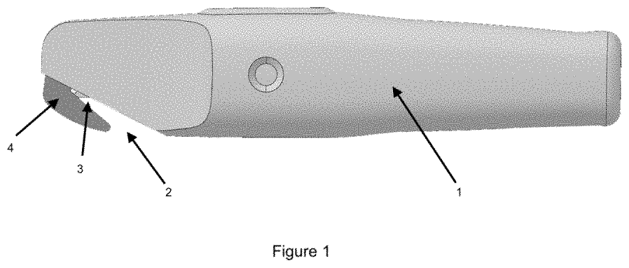

The present invention will now be described by referencing the appended figures representing preferred embodiments. FIG. 1 depicts the overall-all device (1) showing the ergonomic design of hand held cutter according to various embodiments of the present invention. It is much easier and faster to cut up cardboard packaging and boxes, while also being very safe, eliminating knife injuries. It has a handheld ergonomic compact design and uses a rechargeable battery-operated motor, to drive a protected concealed oscillating cutting blade, to ease the task of slicing various thicknesses of cardboard.

FIG. 1 also illustrates the hooked cutting slot (2), which safely guides the cardboard to be cut, into cutting blade area (3). The design of the device houses the cutting blade within a protective cutting slot. This slot allows pieces of cardboard to be slid into an oscillating cutting blade. While the cutting slot allows cardboard of various thicknesses to be fed and cut, it protects human fingers from being cut by the blade. The cutting end of the device is hooked, to allow it to easily slide along and slice long pieces of cardboard.

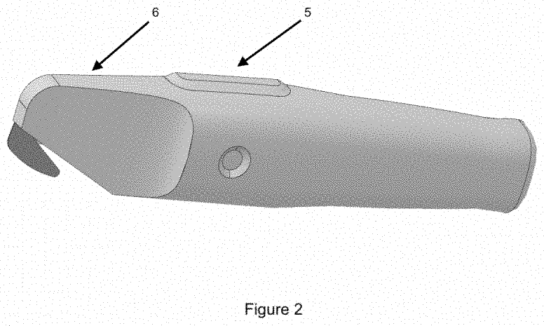

FIG. 2 shows an alternate view of the hand held cutter. illustrating the power controls and blade replacement hatch area. The power controls (5) allow the operator to activate the device. The electric motor is operated by an on/off trigger or switch located on the exterior handle. Some embodiments may offer variable speed options or alternate on/off trigger placement. Some embodiments may utilize variable speeds, while others provide several fixed blade cutting speeds. The cutting blade will wear with time, and is replaceable with a fresh blade, when it becomes dull. The blade access area (6) allows access to a hatch to replace the cutting blade. The cutting blade housed inside may be either a straight or curved design.

This embodiment has the hooked end aligned for a “pull” mode of operation. It allows pulling the device towards the user while cutting. Alternate embodiments include a “PUSH” mode model which has the cutting slot facing away, allowing the device to cut while being pushed away from the user. This further enhances operator safety.

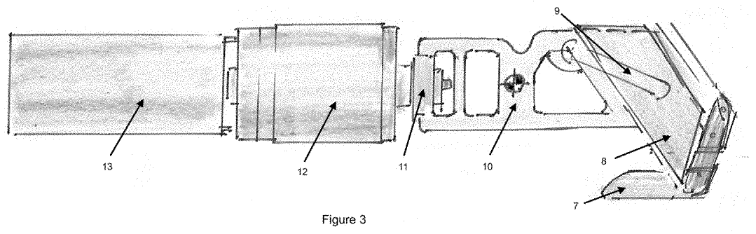

FIG. 3 illustrates the internal operating mechanism. It depicts the mechanism for powering the cutting blade (8) and rocking blade carrier assembly (10). The cutting blade is secured to the blade carrier assembly via the blade clip (9). The blade carrier is mounted on a pivot to achieve efficient cutting action when the blade is rapidly oscillated. The blade carrier assembly is connected to an offset cam (11) which is attached to a small electric motor (12). As the offset cam is rotated by the electric motor, it causes the blade carrier assembly to move back and forth. This back and forth action causes the blade carrier assembly to rock on a pivot point, which in turn causes the cutting blade it houses to move back and forth, achieving an oscillating motion. The oscillating motion of the cutting blade, slices thru pieces of cardboard fed into the blade thru the feed slot. The cam and blade carrier assembly method of attachment allows the electric motor to be mounted such that the motor axis is in line with the handle for a more compact arrangement and eliminates the need for gears to convert the direction of rotation to effect oscillation.

FIG. 3 also illustrates the curved cut stabilizer bar (7) which helps hold the cardboard steady as it is being cut by the blade. The blade carrier assembly is mounted in line with the cut stabilizer bar to minimize friction as the slit in cut cardboard slides over the cut stabilizer bar after being cut. The location of the blade carrier assembly positions the cutting blade such that it forms an acute angle with respect to the leading edge of the cardboard being cut. This angle achieves an efficient sawing action as the cutting blade rapidly oscillates. This design also minimizes jamming of the cardboard as it is being cut.

The electric motor is powered by a rechargeable battery (13). The battery must supply sufficient voltage & current to produce enough torque in the electric motor to easily cut even thick pieces of cardboard.

What is claimed is:

1. A handheld powered box cutter with an ergonomic compact design, using a rechargeable battery-operated motor to power a rapidly oscillating cutting blade, said powered box cutter comprising, a housing with narrow hooked protective cutting slot with the slot opening towards the handle that allows pieces of cardboard to be slid into a rapidly oscillating replaceable cutting blade, protecting from the operators fingers and the cutting blade mounted in a blade carrier assembly positioned such as to allow the blade to cut inserted cardboard pieces at an acute angle, with the cardboard being stabilized by a cut stabilizer bar and said blade carrier assembly is powered by an offset cam mounted on an electric motor.

2. The handheld powered box cutter defined in claim 1, wherein the cutting blade is straight.

3. The handheld powered box cutter defined in claim 1, wherein the cutting blade has a curved end.

4. The handheld powered box cutter defined in claim 1, wherein the device has a fixed cutting speed.

5. The handheld powered box cutter defined in claim 1, wherein the device has a variable cutting speed.

6. The handheld powered box cutter defined in claim 1, wherein the device is powered by an external power source.

7. The handheld powered box cutter defined in claim 1, wherein the protective cutting slot has the opening away from the handle for push cutting.
